(19) United States
(12) Patent Application Publication
(10) Pub. No.: US 2006/0146864 A1
(43) Pub. Date: Jul. 6, 2006

(54) Flexible use of compute allocation in a multi-threaded compute engines

(76) Inventors: Mark B. Rosenbluth, Uxbridge, MA (US); Peter Barry, Co. Clare (IE); Paul H. Dormitzer, Acton, MA (US); Brad A. Burres, Waltham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,386

(22) Filed: Dec. 30, 2004

(51) Int. Cl. H04L 12/43; H04B 7/212

(52) U.S. Cl. 370/458; 370/444

(57) ABSTRACT

Techniques for arbitrating and scheduling thread usage in multi-threaded compute engines. Various schemes are disclosed for allocating compute (execution) usage of compute engines supporting multiple hardware contexts. The schemes include non-pre-emptive (cooperative) round-robin, priority-based round-robin with pre-emption, time division, cooperative round-robin with time division, and priority-based round-robin with pre-emption and time division. Aspects of the foregoing schemes may also be combined to form new schemes. The schemes enable finer control of thread execution in pipeline execution environments, such as employed for performing packet-processing operations.

### FIELD OF THE INVENTION

The field of invention relates generally to networking equipment and, more specifically but not exclusively relates to techniques for arbitrating and scheduling thread usage in multi-thread compute engines.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, etc. These operations are generally referred to as “packet processing” or “packet forwarding” operations.

Modern network processors perform packet processing using multiple multi-threaded processing elements (e.g., processing cores) (referred to as microengines or compute engines in network processors manufactured by Intel® Corporation, Santa Clara, Calif.), wherein each thread performs a specific task or set of tasks in a pipelined architecture. During packet processing, numerous accesses are performed to move data between various shared resources coupled to and/or provided by a network processor. For example, network processors commonly store packet metadata and the like in static random access memory (SRAM) stores, while storing packets (or packet payload data) in dynamic random access memory (DRAM)-based stores. In addition, a network processor may be coupled to cryptographic processors, hash units, general-purpose processors, and expansion buses, such as the PCI (peripheral component interconnect) and PCI Express bus.

In general, the various packet-processing compute engines of a network processor, as well as other optional processing elements, will function as embedded specific-purpose processors. In contrast to conventional general-purpose processors, the compute engines do not employ an operating system to host applications, but rather directly execute “application” code using a reduced instruction set. For example, the microengines in Inte's® IXP2xxx family of network processors are 32-bit RISC processing cores that employ an instruction set including conventional RISC (reduced instruction set computer) instructions with additional features specifically tailored for network processing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a technique for processing multiple functions via multiple compute engines using a context pipeline;

FIG. 2 is a schematic diagram of a microengine architecture including a thread arbiter/scheduler used for selectively activating threads that run on the microengine, according to one embodiment of the invention;

FIG. 3a is a state diagram used in conjunction with a non-pre-emptive round-robin arbitration scheme for activating threads;

FIG. 3b is a state diagram used in conjunction with a pre-emptive round-robin arbitration scheme for activating threads;

FIG. 4 is a timeline diagram illustrating an exemplary thread activation timeline under one embodiment of the non-pre-emptive round-robin arbitration scheme;

FIG. 5 is a timeline diagram illustrating an exemplary thread activation timeline under one embodiment of the pre-emptive round-robin arbitration scheme;

FIG. 6 is a state diagram used in conjunction with a time division scheme for activating threads assigned to respective time slots;

FIG. 7 is a timeline diagram illustrating an exemplary thread activation timeline under one embodiment of the time division scheme;

FIG. 8 is a schematic diagram illustrating a time slot generator, according to one embodiment of the invention;

FIG. 9 is a timeline diagram illustrating an exemplary thread activation timeline under one embodiment of a non-pre-emptive round-robin arbitration scheme with time division;

FIG. 10 is a timeline diagram illustrating an exemplary thread activation timeline under one embodiment of a pre-emptive round-robin arbitration scheme with time division, wherein threads assigned to specific time slots pre-empt threads assigned to shared time slots;

FIG. 11 is a timeline diagram illustrating an exemplary thread activation timeline under one embodiment of a pre-emptive round-robin arbitration scheme with time division, wherein threads assigned to specific time slots may be pre-empted by threads assigned to shared time slots having a higher priority level;

FIG. 12 is a schematic diagram illustrating details of a mechanism for allocating thread usage on a compute engine, according to one embodiment of the invention; and

FIG. 13 is a schematic diagram of a network line card employing a network processor that may employ various embodiments of the thread arbitration and scheduling techniques disclosed herein.

### DETAILED DESCRIPTION

Embodiments of methods and apparatus for arbitrating and scheduling thread usage in multi-threaded compute engines are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Modern network processors, such as Intel's® IXP2xxx family of network processors, employ multiple multi-threaded processing cores (e.g., microengines) to facilitate line-rate packet processing operations. Some of the operations on packets are well-defined, with minimal interface to other functions or strict order implementation. Examples include update-of-packet-state information, such as the current address of packet data in a DRAM buffer for sequential segments of a packet, updating linked-list pointers while enqueuing/dequeuing for transmit, and policing or marking packets of a connection flow. In these cases the operations can be performed within the predefined-cycle stage budget. In contrast, difficulties may arise in keeping operations on successive packets in strict order and at the same time achieving cycle budget across many stages. A block of code performing this type of functionality is called a context pipe stage.

In a context pipeline, different functions are performed on different microengines (MEs) as time progresses, and the packet context is passed between the functions or MEs, as shown in FIG. 1. Under the illustrated configuration, z MEs 100_{0-z} are used for packet processing operations, with each ME running n threads. Each ME constitutes a context pipe stage corresponding to a respective function executed by that ME. Cascading two or more context pipe stages constitutes a context pipeline. The name context pipeline is derived from the observation that it is the context that moves through the pipeline.

Under a context pipeline, each thread in an ME is assigned a packet, and each thread performs the same function but on different packets. As packets arrive, they are assigned to the ME threads in strict order. For example, there are eight threads typically assigned in an Intel IXP2800® ME context pipe stage. Each of the eight packets assigned to the eight threads must complete its first pipe stage within the arrival rate of all eight packets. Under the nomenclature illustrated in FIG. 1, MEij, i corresponds to the ith ME number, while j corresponds to the jth thread running on the ith ME.

Under a functional pipeline, the context remains with an ME while different functions are performed on the packet as time progresses. The ME execution time is divided into n pipe stages, and each pipe stage performs a different function. As with the context pipeline, packets are assigned to the ME threads in strict order. There is little benefit to dividing a single ME execution time into functional pipe stages. The real benefit comes from having more than one ME execute the same functional pipeline in parallel.

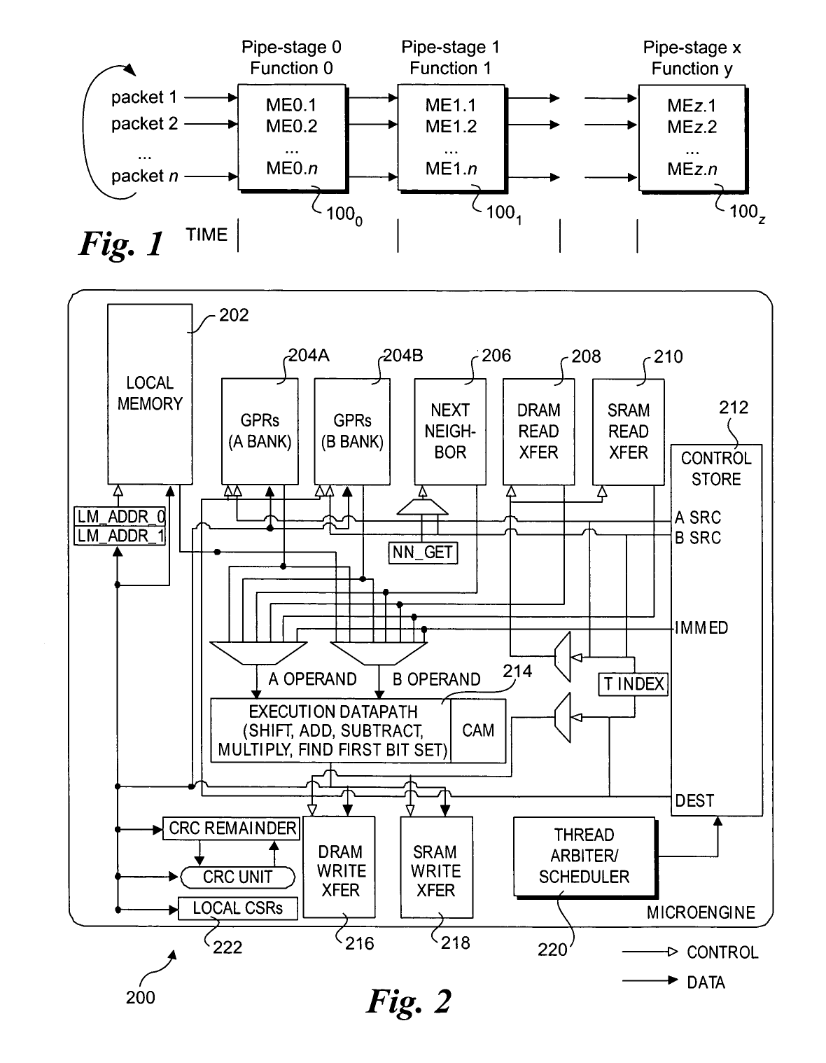

A block diagram corresponding to one embodiment of a microengine architecture 200 is shown in FIG. 2. Architecture 200 depicts several components typical of compute-engine architectures, including local memory 202, general-purpose register banks 204A and 204B, a next neighbor register 206, a DRAM read transfer (xfer) register 208, an SRAM read transfer register 210, a control store 212, execution datapath 214, a DRAM write transfer register 216, and a SRAM write transfer register 218. The architecture also includes a thread arbiter/scheduler 220, which determines the order and duration of thread execution in accordance with the embodiments described below.

Architecture 200 support n hardware contexts. For example, in one embodiment n=8, while in other embodiments n=16 and n=4. Each hardware context has its own register set, program counter (PC), condition codes, and context specific local control and status registers (CSRs) 222. Unlike software-based contexts common to modern multi-threaded operating systems that employ a single set of registers that are shared among multiple threads using software-based context swapping, providing a copy of context parameters per context (thread) eliminates the need to move context specific information to or from shared memory and registers to perform a context swap. Fast context swapping allows a thread to do computation while other threads wait for input/output (IO) resources (typically external memory accesses) to complete or for a signal from another thread or hardware unit.

Under the embodiment illustrated in FIG. 2, the instructions for each of the threads are stored in control store 212. However, this does not imply that each thread executes the same instructions and thus performs identical tasks. Rather, the instructions are typically structured to perform multiple tasks. Generally, execution of the multiple tasks are structured to support multi-threaded processing techniques, wherein a given set of tasks are performed on a respective object being handled by a network processor that includes multiple microengines, such as packet forwarding operations. For example, in one embodiment the set of tasks performed by a given microengine correspond to a sub-set of overall tasks performed by a layer 2 application (e.g., one thread manages data movement from memory, another does header processing, etc.) As discussed above, a particular set of tasks may be performed by threads running on one or more microengines in a cooperative manner.

In order to perform efficient pipeline-based processing, there needs to be a mechanism for controlling thread execution. Although each thread has its own context, only one thread (the active thread) is executing at any point in time. This mechanism is provided by thread arbiter/scheduler 220 in microengine architecture 200.

Under respective embodiments, thread arbiter/scheduler 220 supports various thread arbitration policies facilitates by corresponding modes. These include: 1) non-pre-emptive (cooperative) round-robin; 2) priority-based round-robin with pre-emption; 3) time division; 4) cooperative round-robin with time division; and 5) priority-based round-robin with pre-emption and time division. Arbitration policies employing aspects of combinations of these modes may also be implemented in view of the teachings disclosed herein.

Non-Pre-Emptive (Cooperative) Round Robin

The non-pre-emptive round robin modes employs a conventional round-robin thread execution scheme currently employed by microengines in network processors manufactured by Intel® Corporation (e.g., IXP2xxx). Although this technique is known, it is provided herein to better understand how the cooperative with time division policy may be implemented. Under the round robin policy, threads ready to execute are activated in a round-robin manner. However, the length of execution of a particular thread is variable, as once a thread becomes active, it executes until it relinquishes control (e.g., by issuing a Context Arbitration instruction).

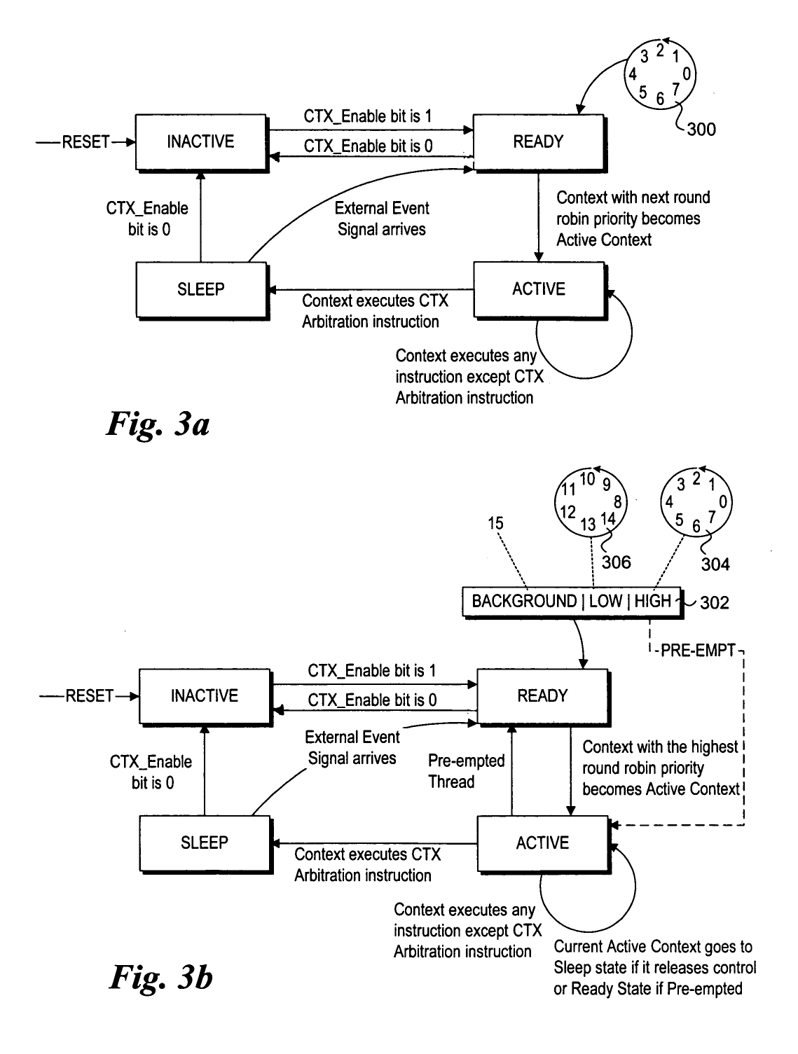

FIG. 3a shows a state diagram illustrating the context state transitions for one embodiment of the non-pre-emptive round-robin mode. Each context will be in one of four states: 1) Inactive; 2) Ready; 3) Active; and 4) Sleep. (As used below, the terms “context” and “thread” are used interchangeably.) At most, one context can be in the Active state at one time, while any number of contexts can be in any of the other states.

A context is in the Inactive state when it is not used. This can be accomplished e.g. by having a CSR with enable bits for each Context, and leaving the enable bit for an unused Context as a ‘0’.

A context is in the Active state when is executing instructions. This Context is called the “Active Context”. The Active Context's PC is used to fetch instructions from control store 212. In non-pre-emptive Round Robin mode, a context will stay in this state until it executes a special Context Arbitration instruction which causes it to relinquish execution. That instruction causes it to go to the Sleep state; the key point is that there is no hardware interrupt or pre-emption; context swapping is completely under software control.

In the Ready state, a context is ready to execute, but is not executing because a different context is currently the Active Context. In the non-pre-emptive round robin mode, when the current Active Context goes to a Sleep state, thread arbiter/scheduler 220 selects the next context to go to the Active state from among all the contexts in the Ready state. In the non-pre-emptive round robin mode, the next context to go to the Active state is selected using round-robin selection. In one embodiment a circular pointer scheme is employed for facilitating round-robin selection, as depicted by circular pointer 300. A context in the Ready state will go to the Sleep state when it executes a Context Arbitration instruction. The Context will remain in the Sleep state until all of the external events that it is waiting upon complete, upon which it will go to Ready state.

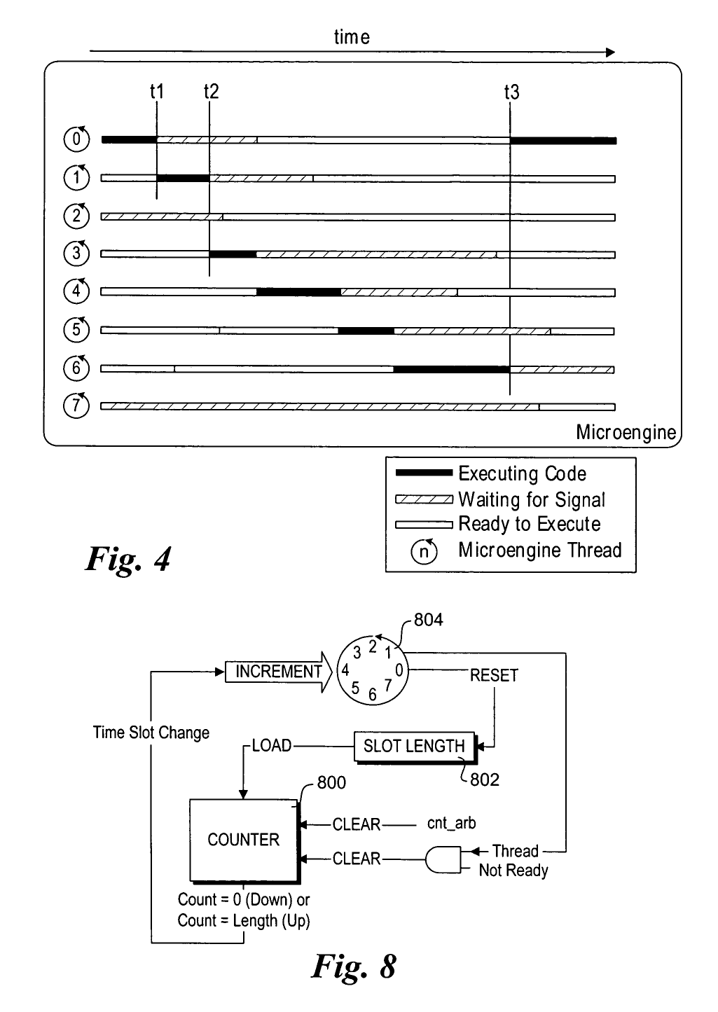

A timeline diagram illustrating thread activity corresponding to an exemplary sequence of thread events on a microengine employing eight threads (contexts) using the non-pre-emptive round-robin arbitration mode is shown in FIG. 4. At the beginning of the timeline, thread 0 is the Active thread and is executing instructions stored in control store 212 while the other threads 1-7 are either waiting for responses from other hardware units (e.g., a memory access) (depicted as “waiting for signal” in FIG. 4) or are in the Ready state. At the time marked t1, thread 0 issues a memory read and explicitly releases control of the microengine (using the Context Arbitration instruction) to wait for that memory access to complete. In response, the pointer in circular pointer 300 is incremented by one to point to the next thread in the round-robin sequence. In this case, the thread is thread 1, which is in the Ready state. Accordingly, thread 1 becomes the new Active thread. At time t2, thread 2 releases control in conjunction with a second memory access. As before, the circular point is incremented by one, and now points to thread 2. However, thread 2 is waiting for a prior memory access to be completed, and thus is in the Sleep state and not ready for execution. As a result, circular pointer 300 is again incremented by one to point to thread 3. This thread is in the Ready state, and thus becomes the new Active thread. The sequence continues in a similar manner, wherein threads 4, 5, and 6 are dispatched after their respective prior threads have released control. At time t3, thread 6 has just released control, which causes circular pointer 300 to be incremented to point to thread 7. Since this thread is in the Sleep state, circular pointer 300 is incremented by one to return to thread 0, which is in the Ready state and becomes the new Active thread.

Priority-Based Round-Robin with Pre-Emption

FIG. 3b shows a state diagram illustrating the context state transitions for one embodiment of the priority-based round-robin with pre-emption mode. Overall, this arbitration mode employs the same states as the non-pre-emption round-robin mode shown in FIG. 3a and discussed above. However, this mode adds further functionality related to thread priority and pre-emption.

Under the priority aspect, each context in Ready state will be arbitrated using one of two or more priority levels. In the exemplary embodiment illustrated in FIG. 3b, there are 16 threads including 8 threads assigned to a high priority level, 7 threads assigned to a low priority level, and one thread assigned to a background priority level. In one embodiment, the priority level of a given thread is identified by a bit or bits stored in its context's Local CSR, as depicted by a priority register 302 in FIG. 3b. Within each priority level, the arbitration is round robin. Accordingly, a circular pointer 304 having 8 thread pointers is provided for the 8 high-priority threads, while a circular pointer 306 having 7 thread pointers is provided for the 7 low-priority threads in the embodiment of FIG. 3b. Since there is only one background thread, there is no need for a separate circular pointer. In general, a circular pointer will be provided for each priority level having two or more threads.

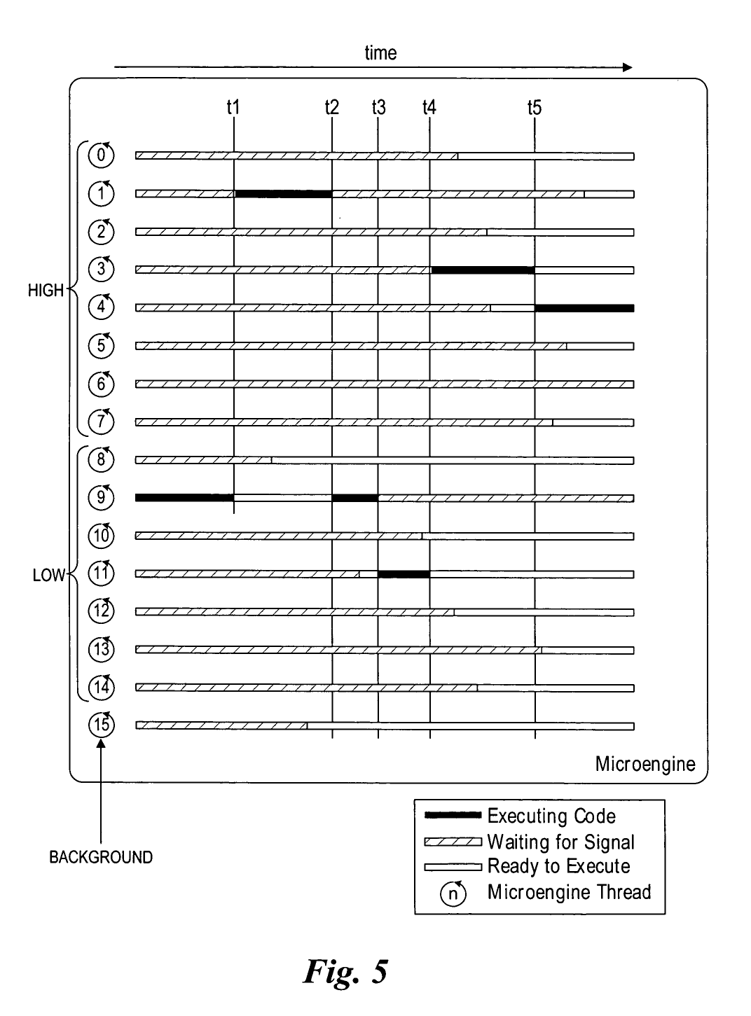

Under one embodiment of the priority-based round-robin with pre-emption mode, a thread context having a higher priority level may pre-empt execution of a context having a lower priority level. For example, suppose thread 9 is the current Active thread, as shown in FIG. 5. This thread has a low priority level. Thread 9 will continue to execute until either 1) it explicitly releases control via a Context Arbitration instruction; or 2) the state of one of high-priority threads 0-7 is changed to the Ready state, as shown by thread 1 at time t1 in FIG. 5. Under this latter situation, thread 1 is selected to replace the current lower-priority thread 9 as the Active thread, thus pre-empting execution of the lower-priority thread. Since the pre-empted thread is yet to complete, it is returned to the Ready state rather than the Sleep state. Also, the circular pointer corresponding to the priority level for the thread that is pre-empted (e.g., circular pointer 306 in this example) is not incremented, as would be the case if thread 9 was returned to the Sleep state. Because there is a separate context maintained for each thread, pre-emption of a thread introduces very little overhead, and does not require any temporal data to be moved.

After a higher-priority thread releases control, arbitration of the threads in the Ready state begins anew. In the present example, suppose that at time t2 thread 1 explicitly releases control, and that none of threads 0 or 2-7 changes to the Ready state while thread 1 is Active. In this instance, there will be no round-robin arbitration of the high-priority threads, because none are in the Ready state. Accordingly, round-robin arbitration proceeds to the next priority level. In this case, thread 9 is selected for the Active state, since it is the thread currently pointer to by circular pointer 306 and it is in the Ready state.

Continuing at time t3 in FIG. 5, at this point thread 9 explicitly releases control in conjunction with a memory access request or the like. This returns thread 9 to the Sleep mode and increments circular pointer 306 to point to thread 10. Since thread 10 is not in the Ready state at time t3, circular pointer 306 is incremented again to point to thread 11. Since thread 11 is Ready, it becomes the Active thread.

At time point t4 the state of thread 3 is changed to Ready. Since thread 3 is at a higher priority level than the current Active thread 11, thread 11 is pre-empted by thread 3, which becomes the Active thread. At time t5, thread 3 explicitly releases control. At this point, each of threads 0, 2, and 4 are in the Ready state. Accordingly, round-robin arbitration is performed for these threads. This entails incrementing circular pointer 304, which points to thread 4, one of the Ready threads. In response, thread 4 becomes the active thread.

Time Division Scheduling

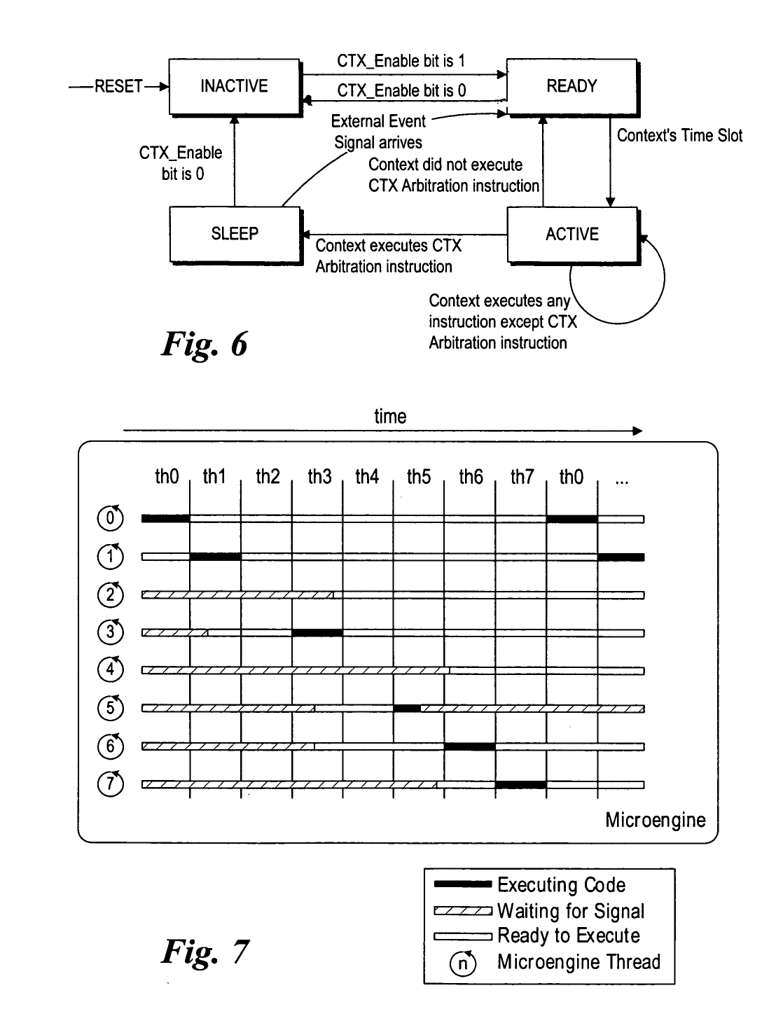

FIG. 6 shows a state transition diagram employed by one embodiment of the time division thread scheduling mode. As before, this mode employs four states including Inactive, Sleep, Ready, and Active. Under one embodiment of the time division approach, time slots are allocated to respective threads. In another embodiment, multiple time slots may be allocated to one or more selected threads. The general idea is to provide activation of the various threads using a time-slicing scheme somewhat akin to that employed in modern operating systems. However, rather than employ a variable number of time slots (as is done with an operating system), the number of time slots is fixed, and time-slot assignments are predefined. As before, only threads in the Ready state may be advanced to the Active state. However, unlike either of the non-pre-emptive or pre-emptive round robin techniques discussed above, a given thread will only be active during its assigned time slot.

FIG. 7 shows a timeline diagram corresponding to one embodiment of the time division thread-scheduling mode. Under this example, eight threads 0-7 are assigned to a respective time slots th0-th7. The time slots are ordered in sequence, with the order returning to time slot th0 after time slot th7 in a cyclical manner. For simplicity, it is assumed the timeline begins at time slot th0.

During time slot th0, thread 0 is the Active thread. At the completion of time slot th0 (which coincides with the start of time slot th1), control is handed of to the next thread 1, if this thread is in the Ready state. Thus, thread 1 is active during time slot th1. However, at the start of time slot th2, thread 2 is not in the Ready state. Accordingly, in one embodiment no thread is active during this instance of time slot th2. At time slot th3, its corresponding thread 3 becomes the Active thread since it is in the Ready state. At time slot th4, thread 4 is not in the Ready state so it is does not become the Active thread. At time slot th5, thread 5 is Ready and thus becomes the Active thread. In this illustrated case, thread 5 explicitly releases control prior to the completion of time slot th5. Under one embodiment, the remainder of the time slot is unused by any threads. This time-slot thread activation sequence continues with activation of thread 6, 7, 0 and 1 in order.

Under one embodiment, full usage of all time slots is provided. For example, in the example of FIG. 7, neither of threads 2 or 4 is read when their corresponding time slot is in effect. Thus, no threads are run during these time slots. To counter this result, when it is determined that a thread assigned to a current time slot is not ready, the time slot is immediately incremented by one to begin the next time slot. Thus, the order of execution corresponding to the example of FIG. 7 would become thread 0, thread 1, thread 3, thread 5, thread 6, thread 7, thread 0 . . . etc.

In a similar manner, in one embodiment explicit release of control causes the time slot to advance to the next time slot. For instance, when thread 5 in FIG. 7 explicitly releases control, the time slot is advanced to th6, thus saving the cycles that would have been wasted during the remaining portion of time slot th5.

In general, a time division scheme may be implemented using one of many well-known timing mechanisms, such as clocks, counters, etc. In one embodiment, a counter 800 is used in conjunction with a time slot length register 802 and a circular pointer 804, as shown in FIG. 8. The time slot length register stores a value used to program counter 800. In one embodiment, the value represents the number of clock cycles per time slot. In another embodiment, a divide-by scheme is used, wherein the counter only counts every nth clock cycle. In one embodiment, a count value is loaded into counter 800, and the value is decremented down with each clock cycle or every nth clock cycle until it reaches 0, whereupon a time slot change event is annunciated. In another embodiment, logic is employed that compares the current counter value with the value in time slot length register 802. When the count (which begins at 0) reaches the length value, a time slot change event is annunciated.

In response to the time slot change event, circular pointer 804 is incremented by one to point to the next thread in the sequence. This causes the Active context to change to the applicable thread, and sends a reset to the counter to start the count over again. This cycle is then repeated on an ongoing basis.

In one embodiment, the time slot is advanced when a current Active thread releases control using a Context Arbitration instruction. In response to this event, counter 800 is cleared, which produces the same result as occurs when the counter reaches 0 (if counting down) or the time slot length value (if counting up). Thus, the time slot is immediately incremented to the next time slot in the sequence.

In a similar manner, in one embodiment counter 800 is cleared when a given thread corresponding to the current time slot is not ready. Accordingly, the time slot is immediately incremented to the next time slot in the sequence.

The net result of the foregoing implementations produce the following thread activation behavior. In one embodiment, threads are run in order, wherein time slots allocated for threads that are not Ready are lost. In another embodiment, the “lost” slots are filled by skipping the non-Ready threads, such that a thread is always executing during each time slot.

Cooperative Round-Robin with Time Division

In accordance with further aspects of embodiments of the invention, the characteristics of the foregoing thread arbitration/scheduling schemes may be combined to form addition thread activation policies. For example, in one embodiment a cooperative round-robin with time division mode is employed. Under this mode, a combination of features from the cooperative (non-pre-emptive) round robin and time division schemes is implemented in a single thread arbitration/scheduling scheme.

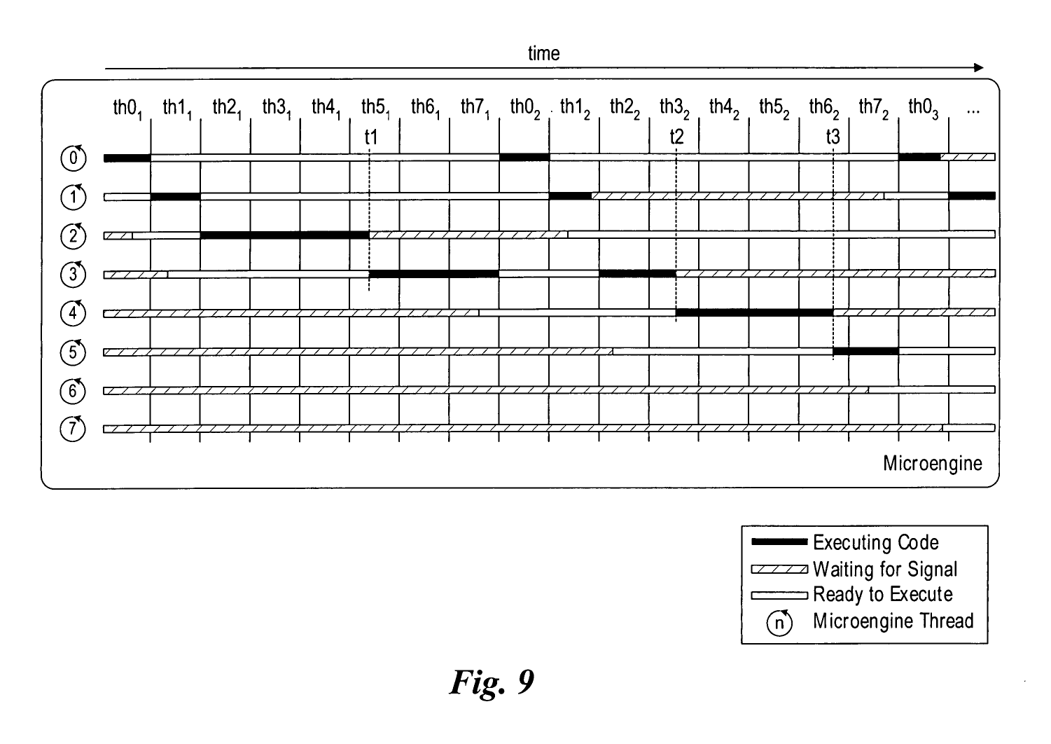

FIG. 9 shows an exemplary implementation of the cooperative round-robin with time division mode. Under this example, each of threads 0 and 1 are assigned to respective time slots th0 and th1. Meanwhile, arbitration among the remaining threads 2-7 is employed to determine which thread is to be activated during time slots th2-th7 for each cycle.

The sequence starts with activation of thread 0 during time slot th0₁ (e.g., the first instance of time slot th0). Thread 0 remains Active through time slot th0₁, whereupon thread 0 becomes the Active thread during time slot th1₁. It is noted that thread 0 did not complete its task, so it is returned to the Ready state rather than the Sleep state. At the close of time slot th0₂, arbitration begins from among thread 2-7. For convenience, it is presumed that the applicable circular pointer used to identify the current round-robin selection points to thread 2. Since this thread is Ready, it becomes the Active thread.

At the beginning of time slot th3₁, thread 2 remains the Active thread since time slots th2-th7 are allocated to threads 2-7 (via appropriate arbitration among this thread pool). This likewise is the situation at the beginning of time slot th4₁ and th5₁. During time slot th5₁, thread 2 explicitly release control at time t1. This causes the next Ready thread in the round-robin sequence to be activated, as depicted by the activation of thread 3 at time t1. As before, thread 3 remains active through the remainder of time slot th5₁ and time slots th6₁, th7₁.

At the start of time slot th0₂, execution of thread t3 is pre-empted in favor of thread 0, the thread assigned to time slot th0. As a result, thread t3 is returned to the Ready state. As before, thread 0 remains active through the end of time slot th0₂, followed by activation of thread 1 during time slot th1₂. Toward the end of this time slot, thread 1 explicitly releases control, causing its state to change to Sleep. Under the illustrated embodiment, no thread is active during the remainder of time slot th1₂. In another embodiment, the following time slot th2₂ immediately commences. In either case, thread activation is returned to the round-robin pool (threads 2-7) at the start of time slot th2₂. Since thread 3 was not completed, it did not return to the Sleep state and thus the circular pointer was not incremented. As a result, since the pointer still points to thread 3 and thread 3 is Ready, thread 3 becomes the Active thread during time slot th2₂ and any following time slots until either thread 3 explicitly releases control or a next instance of time slot 0 is encountered.

In the illustrated example, thread 3 explicitly releases control at time t2, causing the circular pointer to advance to point to thread 4. Since this thread is Ready, it becomes the Active thread during the remainder of time slot th3₂, time slots th4₂ and th5₂ and the first portion of time slot th6₂. At time t3, thread 4 explicitly releases control, and thread 5 becomes the Active thread. Thread 5 remains active through time slot th7₂, at which point it is pre-empted in favor of thread 0, which becomes the new Active thread. The thread arbitration proceeds over time in a similar manner.

Priority-Based Round-Robin with Pre-Emption and Time Division

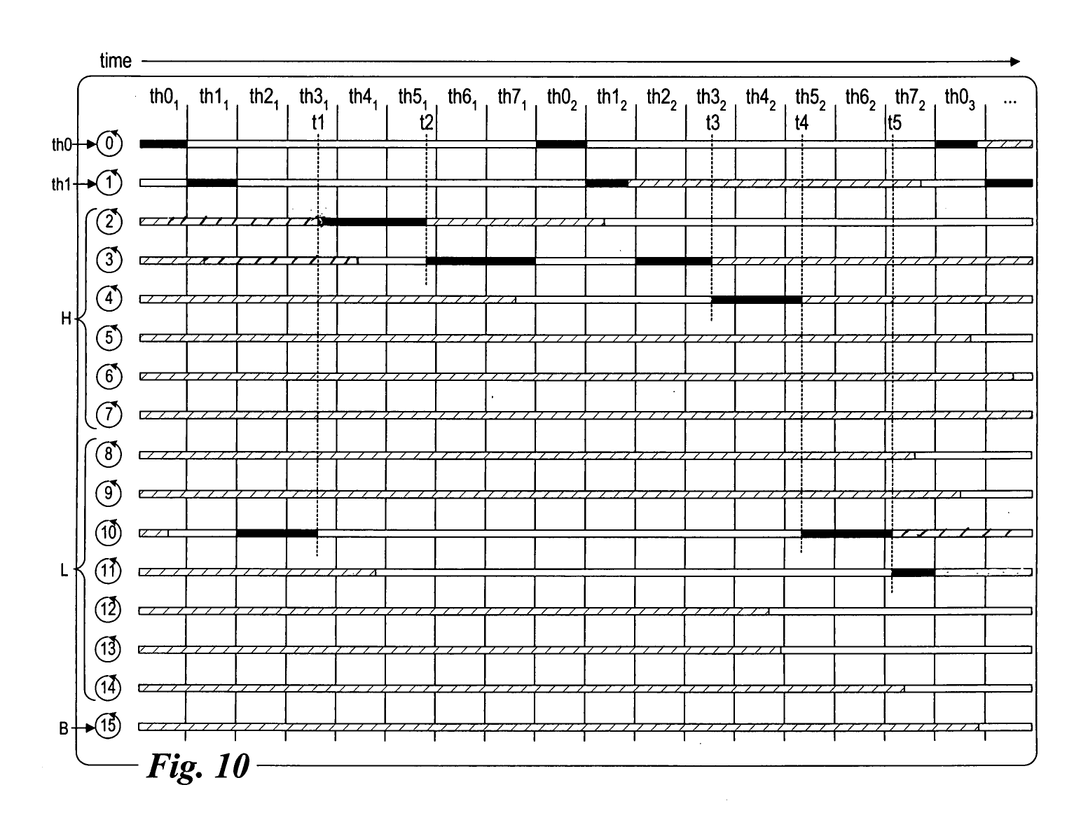

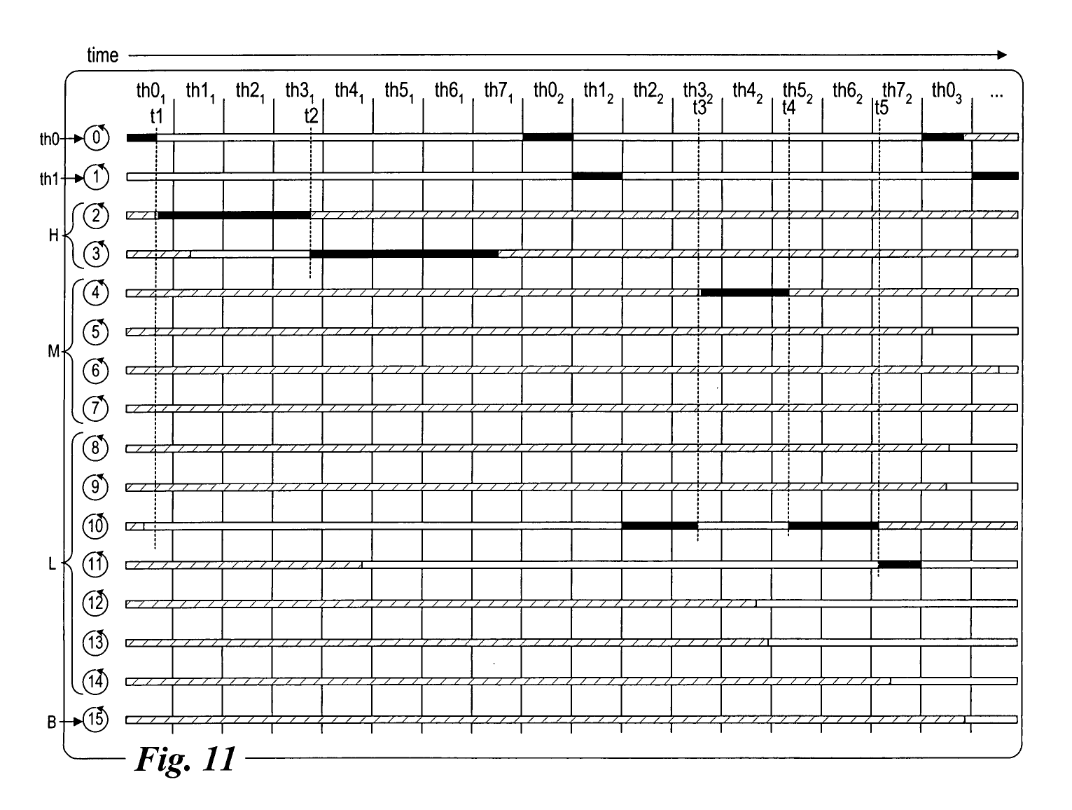

Timelines illustrating thread arbitration corresponding to respective embodiments of priority-based round robin with pre-emption and time division modes are shown in FIGS. 10 and 11. Under the embodiment of FIG. 10, threads 0 and 1 are assigned to time slots th0 and th1, respectively. The remaining threads are allocated to either a high-priority pool (H) (threads 2-7), a low-priority pool (L) (threads 8-15), or a background priority level (B) (thread 15). Under the embodiment depicted in FIG. 10, the following thread arbitration/scheduling logic is employed. Threads 0 and 1 are always Active during time slots th0 and th1, respectively (if Ready). The remaining time slots t2-t7 are arbitrated among threads 2-15 using priority-based round robin arbitration similar to that discussed above. In this example, higher priority threads pre-empt lower priority threads when one or more higher priority threads become Ready while a lower priority thread is Active. A thread assigned to a time slot (e.g., threads 0 and 1) may not be pre-empted.

The timeline example shown in FIG. 10 proceeds as follows. First, thread 0 is active during time slot th0₁, while thread 1 is active during time slot th1₁. At the beginning of time slot th2₁, thread arbitration is performed among the priority pools. In this case, there are no threads that are Ready in the high priority pool (threads 2-7). Thus, arbitration moves to the low priority pool (threads 8-14). It is presumed that the low priority pool circular pointer points to thread 8. Since this is not ready, the thread is incremented to thread 9 (which is also not Ready) and hence to thread 10, which is Ready. Accordingly, thread 10 becomes the active thread.

At time t1, thread 2 becomes Ready. Since it is in the high-priority pool, it pre-empts thread 10 and becomes the Active thread. It continues as the active thread until time t2, at which point it explicitly releases control and thread arbitration of the high-priority pool is initiated. In this instance the next thread (thread 3) is in the Ready state, and thus becomes the new Active thread. Thread 3 continues until the end of time slot th7₁, at which point it is pre-empted in favor of thread 0, which is assigned to time slot th0₂. Similarly, thread 1 is Active during time slot th1₂.

At the start of time slot th2₂, re-arbitration of the high priority pool commences. Since thread 3 was pre-empted, it is still Ready and the circular pointer still points to it. Thus, thread 3 becomes the Active thread. At time t3, thread 3 explicitly releases control, and re-arbitration selects thread 4 as the next thread to activate. At time t4, thread 4 explicitly release control. At this point, there are no other threads in the high-priority pool that are Active. Accordingly, arbitration of the low-priority pool is commenced.

Since thread 10 was pre-empted at time t1, the low-priority pool circular pointer still points to thread 10 and it is in the Ready state. Thus, thread 10 becomes the active thread, and remains so until time t5. At this point, thread 10 explicitly releases control, and re-arbitration of the low-priority pool selects thread 11 to activate. At time slot th0₃, thread 11 is pre-empted in favor of thread 0, followed by activation of thread 1.

The embodiment of FIG. 11 illustrates an implementation under which a thread assigned to a time slot may be pre-empted by a high-priority thread. In this example, thread 0 and 1 are assigned to time slots th0 and th1, respectively, as above. Threads 2 and 3 are assigned to a high-priority pool (H), while threads 4-7 are assigned to a medium priority pool (M) and threads 8-14 are assigned to a low priority pool (L). Thread 15 is again assigned a background priority level (B). Under the priority scheme, high priority level H is the highest level, followed by time slots th0 and th1, medium priority level M, low priority level L, and the background priority level. Accordingly, a Ready thread in high priority level H may pre-empt an Active thread at any other level, including threads assigned to a time slot (e.g., threads 0 and 1).

This situation is illustrated in FIG. 11, wherein thread 0 is pre-empted at time t1 during time slot th0₁ in favor of thread 2. At time t2, thread 2 explicitly releases control, and arbitration of the high-priority pool leads to activation of thread 3. Thread 3 then remains active until it explicitly releases control during time slot th7₁. At time slot th0₂, thread 0 becomes Active, followed by thread 1 during time slot th1₂. This occurs even though thread 10 is Ready, as threads 0 and 1 are assigned to a higher priority level (a time slot) than thread 10.

At time end of time slot th1₂, the thread pools are re-arbitrated. In this instance, there are no threads that are ready in either of the high- or medium-priority pools. Thus, arbitration of the low-priority pool is performed. In this instance, thread 10 becomes the Active thread. At time t3, thread 4 becomes Ready, causing thread 10 to be pre-empted. At time t4, thread 4 explicitly releases control, returning activation to Thread 10 via the associated priority pool arbitration. At time t5, thread 10 explicitly releases control, leading to activation of thread 11. Thread 11 is then pre-empted by thread 0 in concurrence with the beginning of time slot th0₃.

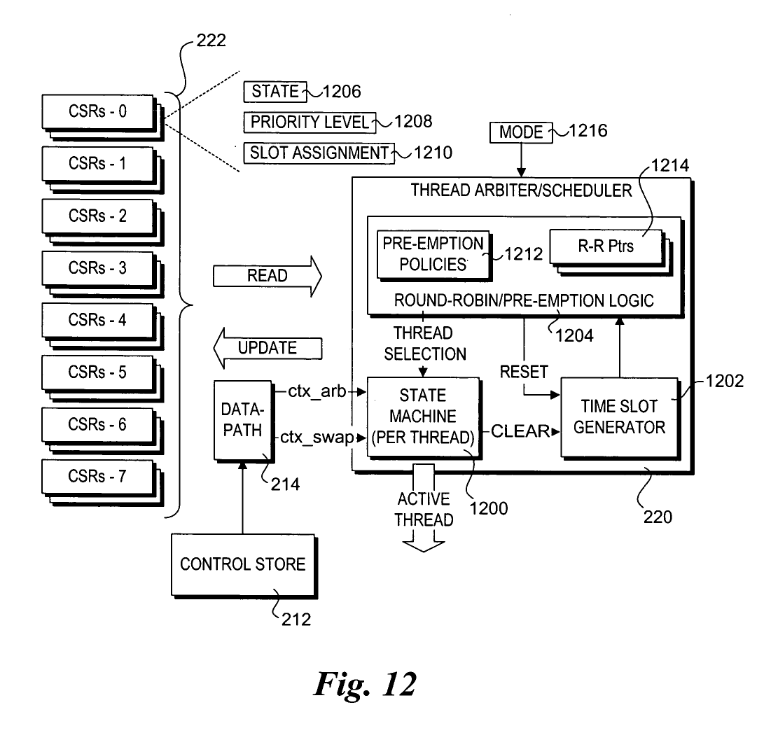

FIG. 12 shows further details of the interaction between thread arbiter/scheduler 220 and other compute engine components, as well as additional support registers and register data. In one embodiment, thread arbiter/scheduler 220 includes a state machine 1200, a time slot generator 1202, and round-robin/pre-emption logic 1204. In general, state machine 1200 is illustrative of the various state machines discussed above, such as, but not limited to, those shown in FIGS. 3a, 3b, and 5. State machine 1200 maintains state information for each of n threads. In the illustrated embodiment, n=8. In one embodiment, thread arbiter/scheduler includes a separate set of state machine logic for each thread. In another embodiment, the state machine logic may comprise a single set of logic that provides multiplexed operations for managing the state of each thread.

In general, various thread-specific information is maintained in respective CSRs for each thread. As depicited by CSRs 222, a given set of CSRs for a compute engine are partitioned into respective groups of CSRs such that each thread has its own group of CSRs. In addition to conventional CSR usage (e.g., for that employed by an Intel® IPX2xxx network processor), each group of CSRs includes register space for storing the thread's current state 1206, priority level 1208 (if applicable), and time slot assignment 1210. During ongoing operations, CSRs 222 are read and updated by thread arbiter/scheduler 220.

Time slot generator 1202 is used to generate time slots. In one embodiment, time slot generator 1202 employs components similar to those shown in FIG. 8 and discussed above. Other circuit configurations for generating time slots may also be implemented using well-known techniques.

Round-robin/pre-emption logic 1204 includes logic for implementing the thread arbitration schemes discussed herein. It includes logic to implement pre-emption policies 1212, and provides a round-robin pointer 1214 (e.g., similar to circular pointers 300, 304, 306 and 804) for each priority level supported by thread arbiter/scheduler 220. The particular thread selection policy to implement is controlled by data stored in a mode register 1216.

In general, the logic for implementing the various block functionality and components depicted in the figures herein may be implemented via hardware, software, or a combination of hardware and software. Typically, programmed logic in hardware will be used to implement the block functionality. However, some of the block functionality may be facilitated via execution of software, as described below.

The round-robin aspects of the foregoing thread arbitration schemes refer to basic round-robin schemes for purpose of illustration. It will be understood that these are merely examples of a round-robin-based scheme that may be implemented for performing this aspect of the thread arbitration. For example, a weighted round-robin scheme may be employed using one of many well-known weighted round-robin algorithms. Other types of round-robin-based schemes may also be employed.

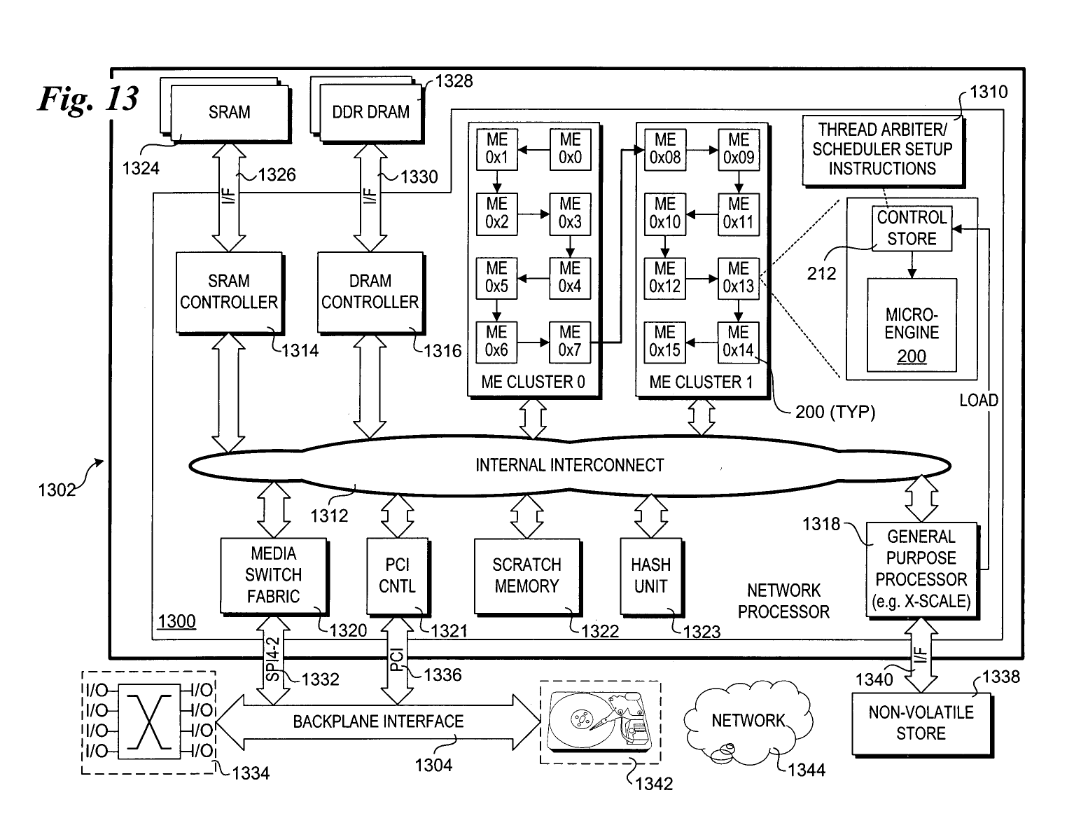

FIG. 13 shows an exemplary implementation of a network processor 1300 that includes one or more compute engines (e.g., microengines) that implement the thread arbitration and scheduling operations discussed herein. In this implementation, network processor 1300 is employed in a line card 1302. In general, line card 1302 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 1304. In general, backplane interface 1304 supports various input/output (I/O) communication channels, as well as provides power to line card 1302. For simplicity, only selected I/O interfaces are shown in FIG. 13, although it will be understood that other I/O and power input interfaces also exist.

Network processor 1300 includes n microengines 200. In one embodiment, n=8, while in other embodiment n=16, 24, or 32. Other numbers of microengines 200 may also me used. In the illustrated embodiment, 16 microengines 200 are shown grouped into two clusters of 8 microengines, including an ME cluster 0 and an ME cluster 1.

In the illustrated embodiment, each microengine 200 executes instructions (microcode) that are stored in a local control store 1308. Included among the instructions for one or more microengines are thread arbiter/scheduler setup instructions 1310 that are employed to setup operation of the various thread arbitration and scheduling operations described herein. In one embodiment, the thread arbiter/scheduler setup instructions instructions are written in the form of a microcode macro.

Each of microengines 200 is connected to other network processor components via sets of bus and control lines referred to as the processor “chassis”. For clarity, these bus sets and control lines are depicted as an internal interconnect 1312. Also connected to the internal interconnect are an SRAM controller 1314, a DRAM controller 1316, a general purpose processor 1318, a media switch fabric interface 1320, a PCI (peripheral component interconnect) controller 1321, scratch memory 1322, and a hash unit 1323. Other components not shown that may be provided by network processor 1300 include, but are not limited to, encryption units, a CAP (Control Status Register Access Proxy) unit, and a performance monitor.

The SRAM controller 1314 is used to access an external SRAM store 1324 via an SRAM interface 1326. Similarly, DRAM controller 1316 is used to access an external DRAM store 1328 via a DRAM interface 1330. In one embodiment, DRAM store 1328 employs DDR (double data rate) DRAM. In other embodiment DRAM store may employ Rambus DRAM (RDRAM) or reduced-latency DRAM (RLDRAM).

General-purpose processor 1318 may be employed for various network processor operations. In one embodiment, control plane operations are facilitated by software executing on general-purpose processor 1318, while data plane operations are primarily facilitated by instruction threads executing on microengines 200.

Media switch fabric interface 1320 is used to interface with the media switch fabric for the network element in which the line card is installed. In one embodiment, media switch fabric interface 1320 employs a System Packet Level Interface 4 Phase 2 (SPI4-2) interface 1332. In general, the actual switch fabric may be hosted by one or more separate line cards, or may be built into the chassis backplane. Both of these configurations are illustrated by switch fabric 1334.

PCI controller 1322 enables the network processor to interface with one or more PCI devices that are coupled to backplane interface 1304 via a PCI interface 1336. In one embodiment, PCI interface 1336 comprises a PCI Express interface.

During initialization, coded instructions (e.g., microcode) to facilitate various packet-processing functions and operations are loaded into control stores 1308. Thread arbiter/scheduler setup instructions 1310 are also loaded at this time. In one embodiment, the instructions are loaded from a non-volatile store 1338 hosted by line card 1302, such as a flash memory device. Other examples of non-volatile stores include read-only memories (ROMs), programmable ROMs (PROMs), and electronically erasable PROMs (EEPROMs). In one embodiment, non-volatile store 1338 is accessed by general-purpose processor 1318 via an interface 1340. In another embodiment, non-volatile store 1338 may be accessed via an interface (not shown) coupled to internal interconnect 1312.

In addition to loading the instructions from a local (to line card 1302) store, instructions may be loaded from an external source. For example, in one embodiment, the instructions are stored on a disk drive 1342 hosted by another line card (not shown) or otherwise provided by the network element in which line card 1302 is installed. In yet another embodiment, the instructions are downloaded from a remote server or the like via a network 1344 as a carrier wave.

In general, programs to implement the packet-processing functions and operations, as well as the thread arbitration/scheduler setup operations, may be stored on some form of machine-readable or machine-accessible media, and executed on some form of processing element, such as a microprocessor or the like. Thus, embodiments of this invention may be used as or to support a software program executed upon some form of processing core (such as the CPU of a computer) or otherwise implemented or realized upon or within a machine-readable or machine-accessible medium. A machine-accessible medium includes any mechanism for storing or transmitting information in a form readable by a machine (e.g., a computer). For example, a machine-accessible medium can include such as a read only memory (ROM); a random access memory (RAM); a magnetic disk storage media; an optical storage media; and a flash memory device, etc. In addition, a machine-accessible medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
assigning a respective time slot to each of at least one thread among a plurality of threads to be executed on a compute engine that includes multiple hardware threads;
assigning a remaining portion of time slots including at least one time slot to be used for executing one or more threads that are not assigned to a respective time slot;
activating, for execution on the compute engine, each of the at least one thread assigned to a respective time slot during that thread's assigned time slot; and
selectively activating, for execution on the compute engine, the one or more threads that are not assigned to a respective time slot during the remaining portion of time slots.

2. The method of claim 1, wherein each time slots has the same length, and wherein at least one of the threads not assigned to a respective time slot is assigned to multiple time slots in the remaining portion of time slots.

3. The method of claim 1, wherein multiple threads are not assigned to a respective time slot, the method further comprising:
performing arbitration of the multiple threads to select which of the multiple threads are to be activated during each cycle of the remaining portion of time slots.

4. The method of claim 3, further comprising:
performing round-robin-based arbitration of the multiple threads to select which of the multiple threads are to be activated during each cycle of the remaining portion of time slots.

5. The method of claim 4, further comprising:
determining if a thread selected to be activated by the round-robin-based arbitration is ready to be activated; and if not,
selecting a next thread for arbitration in a round-robin-based sequence corresponding to the round-robin-based arbitration.

6. The method of claim 3, further comprising:
partitioning the one or more threads that are not assigned to a respective time slot into multiple priority pools; and
performing arbitration for at least one of the multiple priority pools to select which thread to activate during a given time slot among the remaining portion of time slots.

7. The method of claim 6, wherein the priority pools include a higher priority pool and a lower priority pool, the method further comprising:
determining if any threads are ready for activation in the higher priority pool; and in response thereto,
performing arbitration of the higher priority pool if any threads are determined to be ready for activation in the higher priority pool; otherwise
performing arbitration of the lower priority pool.

8. The method of claim 6, wherein the priority pools include a higher priority pool and a lower priority pool, the method further comprising:
enabling activation of a thread in the lower priority pool to be pre-empted by activation of a thread in the higher priority pool.

9. The method of claim 3, further comprising:
enabling a thread to explicitly release control of the compute engine; and, in response thereto,
performing re-arbitration of the multiple threads to select which of the multiple threads is next to be activated; and
activating the thread selected by the re-arbitration.

10. The method of claim 1 further comprising:
skipping a given time slot assigned to a respective thread if the respective thread is not ready for activation.

11. The method of claim 1, further comprising:
enabling a thread to explicitly release control of the compute engine; and, in response thereto,
immediately advancing to a next time slot.

12. The method of claim 1, further comprising:
assigning a higher priority level to at least one thread that is not assigned to a respective time slot than each of the at least one thread assigned to a respective time slot; and
enabling a thread assigned to the higher priority level to pre-empt activation of a thread assigned to a respective time slot during that thread's time slot.

13. The method of claim 1, further comprising:
pre-empting activation of a thread that is not assigned to a respective time slot in favor of a thread assigned to a respective time slot during that thread's assigned time slot.

14. The method of claim 13, further comprising:
re-activating the thread that is pre-empted during a next cycle of the remaining portions of time slots.

15. An apparatus, comprising:
at least one compute engine including:
an execution datapath;
registers to support respective hardware contexts for each of a plurality of threads;
a time slot generation mechanism, to generate a fixed number of time slots that are repeated on a cyclical basis;
a mechanism to assign each of the plurality of threads to one of a respective time slot or a shared portion of time slots; and
thread activation logic to control which of the plurality of threads is active to execute on the execution datapath during a given time slot, the thread activation logic including arbitration logic to select which thread or threads to activate during the shared portion of time slots and logic to activate each thread assigned to a respective time slot during that time slot.

16. The apparatus of claim 15, wherein the apparatus comprises a network processor having a plurality of compute engines including said at least one compute engine.

17. The apparatus of claim 15, wherein the thread activation logic enables a thread that is current1y active to explicitly release control of the compute engine it is executing on.

18. The apparatus of claim 17, wherein the thread activation logic prevents a thread from being pre-empted by another thread during the shared portion of time slots while enabling a thread not assigned to a given time slot to be pre-empted by the thread assigned to that time slot.

19. The apparatus of claim 15, further comprising:
a mechanism to assign one of a plurality of priority levels to selected threads,
wherein assignment of priority levels to the selected threads forms a plurality of priority pools having different priority levels, and the thread activation logic enables a thread in a higher priority pool to pre-empt activation of a thread in a lower priority pool.

20. The apparatus of claim 15, wherein the thread activation logic includes a state machine that maintains a current state for each thread, the states including a ready state, an activation state, and at least one other state, and wherein the time slot generation mechanism enables a time slot to be skipped if a corresponding thread assigned to the time slot is not in the ready state.

21. A network line card, comprising:
a backplane interface;
double data-rate dynamic random access memory (DDR-DRAM);
a network processor, operatively coupled to the backplane interface and the DDR-DRAM and including,
an internal interconnect comprising a plurality of command and data buses;
a plurality of multi-threaded compute engines communicatively-coupled to the internal interconnect, at least one of the multi-threaded compute engines including,
an execution datapath;
a time slot generation mechanism, to generate a fixed number of time slots that are repeated on a cyclical basis;
registers to support respective hardware contexts for each of a plurality of threads, including registers to store information identifying whether a given thread is assigned to a respective time slot or a shared portion of time slots; and
a thread arbiter and scheduler having logic to control which of the plurality of threads is active to execute on the execution datapath during a given time slot, the logic including arbitration logic to select which thread or threads to activate during the shared portion of time slots and logic to activate each thread assigned to a respective time slot during that time slot.

22. The network line card of claim 21, wherein the thread arbiter and scheduler prevents a thread from being pre-empted by another thread during the shared portion of time slots while enabling a thread not assigned to a given time slot to be pre-empted by the thread assigned to that time slot.

23. The network line card of claim 21, wherein the thread arbiter and scheduler includes a state machine that maintains a current state for each thread, the states including a ready state, an activation state, and at least one other state, and wherein the time slot generation mechanism enables a time slot to be skipped if a corresponding thread assigned to the time slot is not in the ready state.
